(19) United States
(12) Patent Application Publication
(10) Pub. No.: US 2010/0146578 A1
(43) Pub. Date: Jun. 10, 2010

(54) SYSTEM AND METHOD FOR PROVIDING AN EMBEDDED TEST SIGNAL FROM A MULTIMEDIA PROCESSOR

(76) Inventors: Arvind R. Mallya, Walnut Creek, CA (US); Nathan Edwards, Lewisville, TX (US); Mark Allen Wieland, Kingsland, TX (US)

Correspondence Address: AT&T Legal Department - Roebuck;Attn: Patent Docketing, One AT&T Way,, Room 2A-207, Bedminster, NJ, 07921, US

(21) Appl. No.: 12/329,570

(22) Filed: Dec. 6, 2008

(51) Int. Cl. H04N 7/173

(52) U.S. Cl. 725/131

(57) ABSTRACT

A computer readable medium is disclosed containing computer program instructions that when executed by a computer concurrently send a plurality of test signals from a multimedia processor, the computer program instructions including but not limited to instructions to accept a test initiation signal at the multimedia processor; and instructions to concurrently send at least one of a plurality of test signals from each one of a plurality of output ports on the multimedia processor.

### BACKGROUND

1. Field of Disclosure

The disclosure relates to the field of video data distribution systems and more specifically to systems and methods for testing multimedia processors associated with the video data distribution systems.

2. Description of Related Art

Video data distribution systems typically send video data to multi media processors (MMPs) which receive and decode the video data from the video data distribution system. Content providers deliver content via broadcasts to a number of MMPs and/or deliver content via on-demand processing based on requests received and content availability. A content provider typically encrypts and multiplexes the primary and alternative content in channels for transmission to various cable head ends. These signals are de-multiplexed and transmitted to integrated receiver decoders (IRDs) which decrypt the content. These IRDs are MMPs typically referred to as set top boxes (STBs) as they often sit on top of a home television which display video received by the STB from the data distribution system.

### BRIEF DESCRIPTION OF THE DRAWINGS

For detailed understanding of the illustrative embodiment, references should be made to the following detailed description of an illustrative embodiment, taken in conjunction with the accompanying drawings, in which like elements have been given like numerals.

FIG. 1 is a data flow diagram showing an illustrative embodiment of data exchanged and process in a particular illustrative embodiment;

FIG. 2 is a schematic depiction of a multimedia processor (MMP) sending test signals in a household in an illustrative embodiment;

FIG. 3 is a depiction of an illustrative embodiment of a front view of a MMP;

FIG. 4 is a depiction of an illustrative embodiment of a back view of a client MMP;

FIG. 5 is a depiction of a of a graphical representation of a MMP on a MMP display in an illustrative embodiment;

FIG. 6 is a depiction of a flow chart of functions executed in a particular illustrative embodiment; and

FIG. 7 is a diagrammatic representation of a machine in the form of a computer system within which a set of instructions, when executed, may cause the machine to perform any one or more of the methodologies of the illustrative embodiment.

### DETAILED DESCRIPTION OF THE DISCLOSURE

In the following description, for purposes of explanation, numerous specific details are set forth in order to provide a thorough understanding of an embodiment of the present invention. It will be evident, however, to one skilled in the art that the present invention may be practiced without these specific details. This disclosure describes a system, method and computer program product for providing a plurality of test signals concurrently from a multimedia processor (MMP) such as a set top box. The multi media processor receives video, audio and graphic data from a data distribution system, processes the data and presents it an audible and visible presentation on peripherals (such as a television with loud speaker) in data communication with the MMP via wires or wireless connectivity. The MMP also hosts the method, system and computer program product disclosed herein. In an illustrative embodiment, a MMP such as a set top box sends audio, video and communication signals concurrently on STB output ports to enable a user to verify that an STB installation is operational when configured in connection with a plurality of peripheral devices such as a television and speakers. In a particular illustrative embodiment, at least one test signal is sent from each output port on the STB.

A particular illustrative embodiment provides known signal sources from all of the STB output ports to confirm that the STB is electronically functional and that the cabling between the STB and STB peripheral devices is working correctly to establish connectivity and that the peripherals such as televisions and audio visual recorders (AVRs) are set up correctly and able display images and reproduce sounds. In a particular embodiment a system, method and computer program product are provided that initiate the functionality described herein in response to holding down both the left and right arrow buttons on the STB front panel during power up. In a particular embodiment, the left and right arrow buttons are held down until test image is seen and/or the test audio is heard on STB peripheral devices. The STB automatically sends test output signals from all STB output ports.

In a particular embodiment, the STB further responds by sending a video output signal on all video display output ports (also referred to herein as interfaces) with a default aspect ration of 4×3 for display on an STB display peripheral such as a television. The output ratio can be changed by pressing either the right or left arrow to display a higher or lower resolution setting as well as displaying a corresponding test pattern for the higher or lower resolution. Three resolutions (480i, 1080i and 720p) of test patterns are output for display sequentially on all video output ports or interfaces, which allows an end user at the STB to connect peripherals to any and all outputs to confirm that connectivity is established and working between the STB and the peripherals. In another embodiment a test video digital video recording is performed by recording a video test signal and playing the test signal back from the DVR at a video output port. Stereo audio tones are sent to all audio output ports. The application is terminated by initiating a normal reboot by pressing the power button for 5 to 10 seconds. In another particular embodiment a video display signal and audio test signal are sent to another device such as mobile telephone or computer using an STB on board WiFi or a high speed video wireless transceiver.

In another illustrative embodiment, an STB sound reproductive device such as a speaker or a piezoelectric device reproduce the test audio sounds that are sent to the audio out put ports. In another illustrative embodiment, test audio signals sent to the audio output ports are audio descriptions of the video test images and video test patterns sent to the video output ports. In another illustrative embodiment, test video signals sent to the video output ports are video descriptions of the audio test signals sent to the audio output ports.

In another illustrative embodiment a computer readable medium is disclosed containing computer program instructions that when executed by a computer concurrently send a plurality of test signals from a multimedia processor (MMP), the computer program instructions including but not limited to instructions to accept a test initiation signal at the MMP and instructions to concurrently send at least one of a plurality of test signals from each one of a plurality of output ports on the MMP.

In another embodiment of the medium, the computer program further comprises instructions to present on the MMP, a working indication, perceptible on the MMP that all MMP output ports are operational. In another embodiment of the medium, at least one of the plurality of test signals further comprise a visual presentation of the MMP output ports for presentation on a MMP display.

In another embodiment of the medium, the computer program further includes but is not limited to instructions to accept selection input data indicating one of the MMP output ports, the computer program further comprising instructions to present an instructional message explaining operation of the MMP output port. In another embodiment of the medium, the instructional message further includes but is not limited to data selected from the group consisting of graphical, video and audio data. In another embodiment of the medium, the computer program further includes but is not limited to instructions to present a representation of a peripheral device from the output port. In another embodiment of the medium, the test signals are data selected from a group consisting of video, audio, communication and optical data. In another embodiment of the medium, the working indication consists of data selected from the set consisting of audible and visible data.

In another embodiment, a system is disclosed for providing a plurality embedded test signals from a MMP, the system including but not limited to a MMP, a processor in the MMP, wherein the processor is in data communication with a computer readable medium on the MMP; a first interface to accept a test initiation signal at the MMP; a second interface to send a first test signal from the MMP; and a third interface to send a second test signal concurrently with the first test signal from the MMP. In another illustrative embodiment, the system further includes but is not limited to a working indication device, perceptible on the MMP operable to indicate that all MMP output ports are operational. In another embodiment of the system, at least one of the first and second test signals further include but are not limited to a visual presentation of the MMP output ports for presentation on a MMP display.

In another embodiment of the system, at least one of the first and second test signals further comprises an audible presentation of an instructional message explaining operation of the MMP output port. In another embodiment of the system, the instructional message further includes but is not limited to data selected from the group consisting of graphical, video and audio data. In another embodiment of the system, the system further includes but is not limited to a device for presenting a representation of a peripheral device from the output port. In another embodiment of the system, the test signals are data selected from a group consisting of video, audio, communication and optical data. In another embodiment of the system, the working indication consists of data selected from the set consisting of audible and visible data.

In another embodiment, a method is disclosed for sending a plurality of test signals from a MMP, the method including but not limited to accepting a test initiation signal at the MMP; and sending concurrently the plurality of test signals from a plurality of output ports on the MMP for testing operation of the MMP and peripherals receiving the test signals from the MMP. In another embodiment of the method, the method further includes but is not limited to presenting on the MMP, a working indication, perceptible on the MMP that all MMP output ports are operational. In another embodiment of the method, at least one of the plurality of test signals further comprise a visual presentation of the MMP out put ports for presentation on a MMP display. In another embodiment of the method, the method further includes but is not limited to accepting a selection input from a user at the MMP, wherein the selection input indicates one of the plurality of MMP output ports, the method further including but not limited to presenting an instructional message explaining operation of the MMP output port.

In another embodiment of the method, the instructional message further comprises data selected from the group consisting of graphical, video and audio data. In another embodiment of the method, the method further includes but is not limited to presenting a representation of a peripheral device suitable for processing data from the output port. In another embodiment of the method, the test signals are data selected from a group consisting of video, audio, communication and optical data. In another embodiment of the method, the method further includes but is not limited to the working indication consists of data selected from the set consisting of audible and visible data.

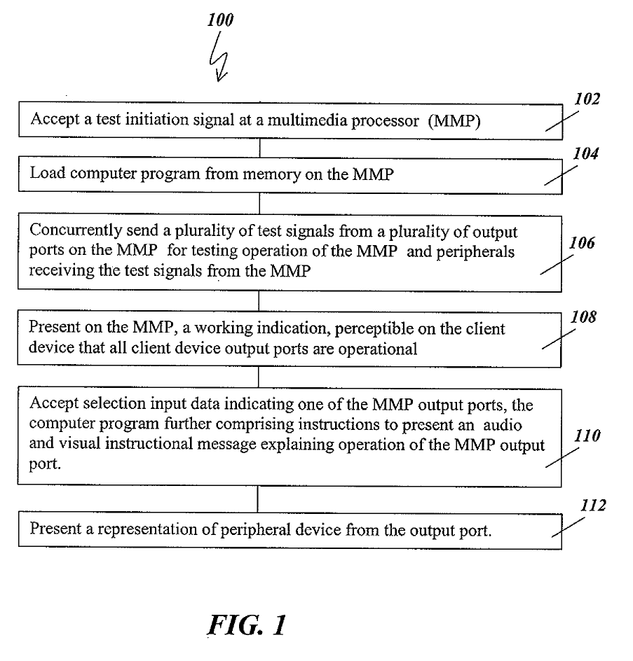

Turning now to FIG. 1, a flow chart illustrating functions performed by an illustrative embodiment of a system, method and computer program product are illustrated. As shown in FIG. 1, at block 102 an illustrative embodiment accepts a test initiation signal at the MMP. The test initiation signal can include a special key sequence on a remote control (RC) for the MMP (STB). An initiation sequence can be defined as holding down the STB front panel left and right buttons during power up. Any available RC key sequence can be utilized for the initiation sequence. The initiation sequence can also be entered into from a power on reset of the STB and exited after a time delay or by entry of any key on the RC.

As shown in FIG. 1, in block 104 the STB then loads computer program data from on-board storage at the STB. The computer program data is stored in non volatile read only memory (ROM) other storage device which maintains data during on and off power cycling. At block 106, the STB concurrently send a plurality of audio and video test signals from its output ports for testing operation of the MMP and peripherals receiving the test signals from the MMP. The STB also sends a message to the network connection and transmits the message to the IPTV system indicating that the STB has run the embedded test, which indicates to the IPTV system that the STB is functioning to communicate to the IPTV system. At block 108, the STB presents on the MMP, a working indication, perceptible on the MMP that all MMP output ports are operational. In another embodiment at least one of the plurality of test signals further include a visual presentation of the MMP output ports for presentation on a MMP display. At block 110, the STB accepts selection input data indicating one of the MMP output ports, the computer program further comprising instructions to present an audible and visible instructional message on an MMP peripheral device explaining operation of the MMP output port. The instructional message includes but is not limited to data selected from the group consisting of graphical, video and audio data. At block 112, the illustrative STB presents a representation of a peripheral device from the output port. The test signals are data selected which can be video, audio, communication and optical data. The working indication consists of data selected from the set consisting of audible and visible data.

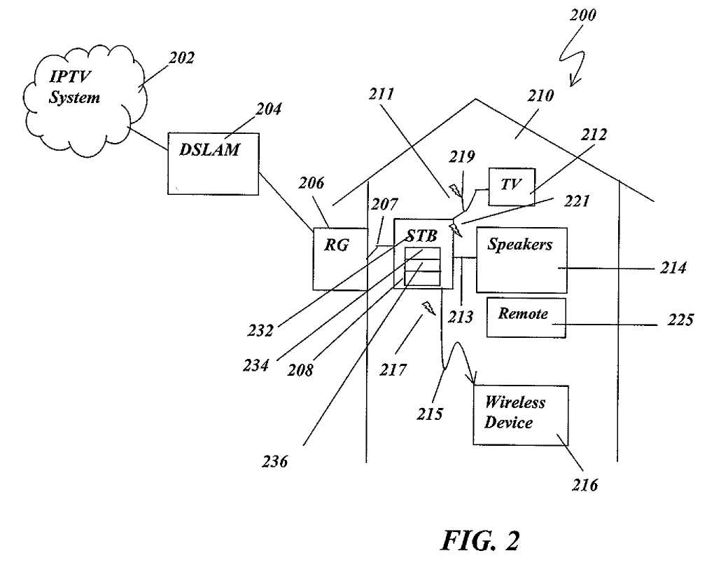

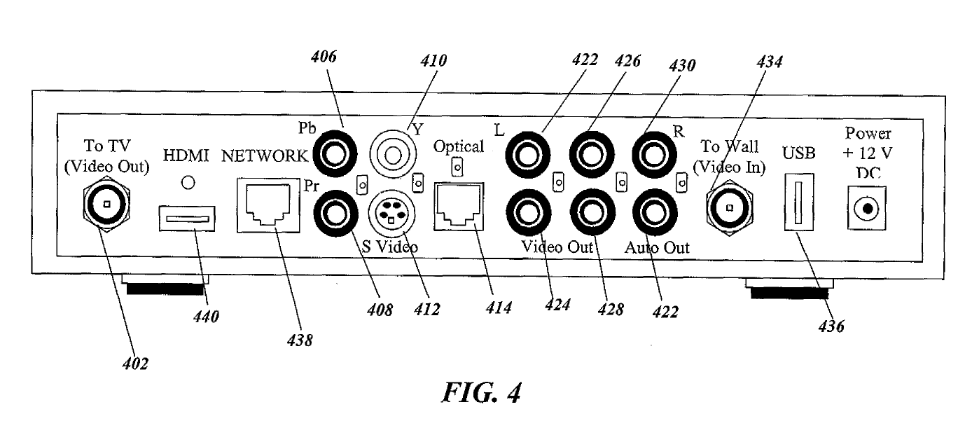

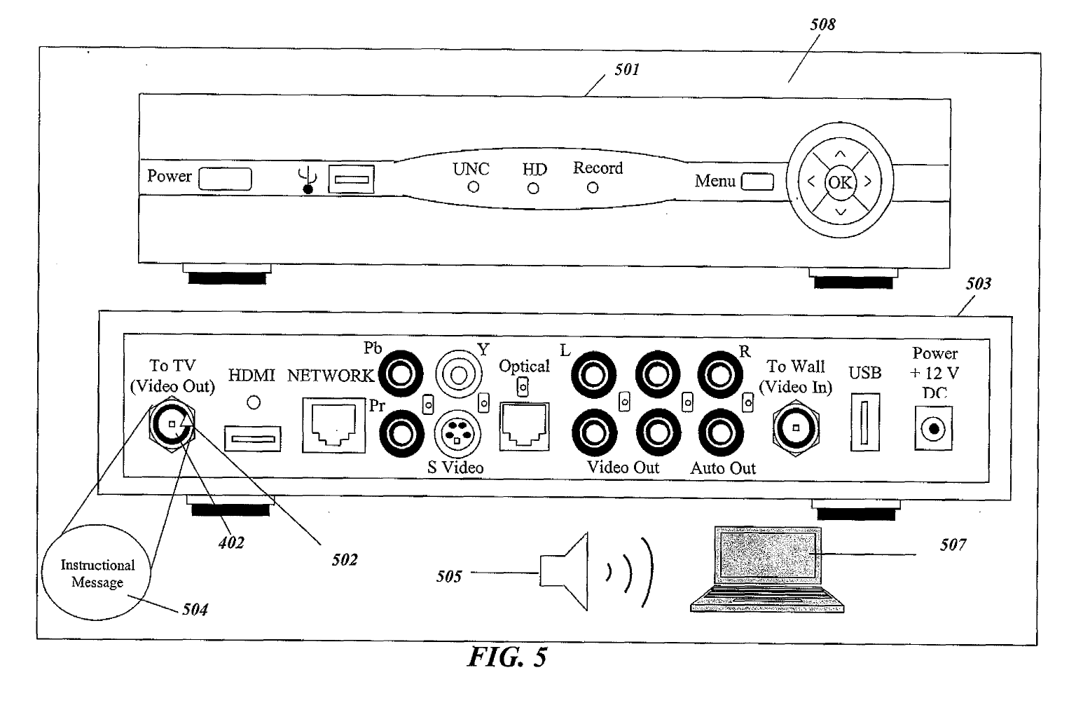

Turning now to FIG. 2, FIG. 2 is a depiction of an illustrative embodiment connected to an and internet protocol television system 202 via digital service accumulator multiplexor (DSLAM) 204 which relays audio and video internet protocol (IP) data from the IPTV system to a gateway such as residential gateway (RG) 206 to the STB. The STB also communicates with the IPTV system by sending digital IP data from a network connection on the STB back through the RG and DSLAM to the IPTV system. As shown in FIG. 2, the STB 208 includes but is not limited to a sound reproductive device such as a loud speaker or piezoelectric device 232, a processor 234 including a computer readable medium including but not limited to a memory and data base, an internal wireless transceiver 236 which can include but is not limited to a WiFi or a high speed video wireless transceiver having video transmission capability and output ports as shown in further detail in FIG. 4. In an illustrative embodiment, the STB concurrently sends audio and video test signals on all output ports, including test signals 219 and 221 to wire 211, 213 connected peripherals such a television 212 and speaker 214. In a particular embodiment the STB is wireless enabled and sends wireless audio and video test signals 217 over wireless communications 215 such as WiFi or a high speed video wireless transceiver to wireless devices 216. Remote control 225 provide data input to the STB including but not limited to test signal interaction and cursor movement and interaction for selecting output ports on a graphic display of the STB as shown in FIG. 5.

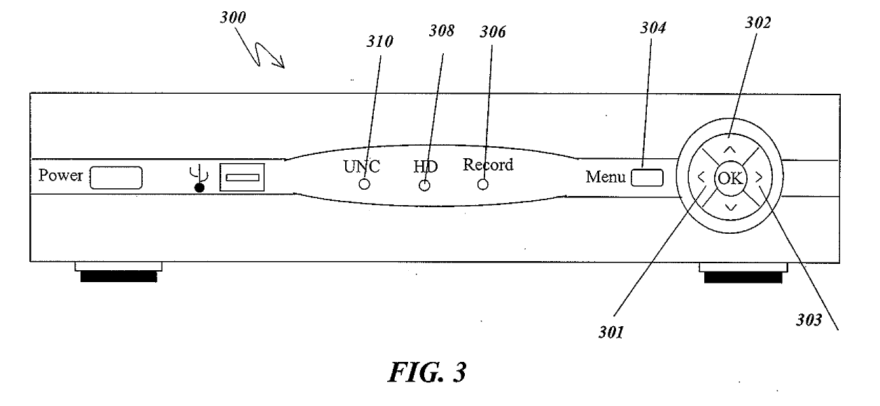

Turning now to FIG. 3, a front view 300 of an illustrative STB MMP 208 front view is depicted along front arrow buttons for initiating the test sequence as shown in FIG. 1. As shown in FIG. 3, front panel buttons 302 include left arrow button 301 and right arrow button 303. Front visual indicators 310, 308 and 306 which are also referred to as lights herein, are typically used for indicating the occurrence of operational functions during normal operation of the STB. Light 306 is a record light that normally indicates when a recording is being made. Light 308 is a HD light that indicates that STB aspect ratio is set to either 720p or 1080i resolution 16×. Light 310 is a link light that indicates that network connectivity is present. In an illustrative embodiment, these lights 306, 308 and 310 are used for test indicators during the testing of audio and video output port connectivity during execution of an illustrative embodiment. A blinking pattern alternating between center visual indicator 308 and left and right indicators 306 and 310 can be used to indicate that the STB is in test mode and that all video and audio ports are currently sending a test video or audio signal.

Turning now to FIG. 4, a back view 400 of the STB 208 is depicted. Out put ports are shown on the back of the STB are depicted in back view 400. As shown in FIG. 4, video and audio output are provided in appropriate format for output ports 402, 406, 408, 410, 412, 414, 422, 424, 426, 428, 430, 432, 436, 438 and 440 during testing initiated in an illustrative embodiment. The STB sends test video and audio data to enable testing of RCA stereo connections, optical audio connections for surround sound, HDMI audio, RF video RF audio, composite video S Video, component video and HDMI video. The STB also sends a message to the IPTV system during the test over the network connection 438. As shown in FIG. 4, in an illustrative STB, which is shown for exemplary purposes only and does not limit the scope of the claimed invention, provides a set of output ports which support various modalities of deliver of video and audio data from the STB. As shown in FIG. 4, the outputs from the STB include but are not limited to WiFi or a high speed video wireless transceiver video data and audio data which the WiFi transceiver or a high speed video wireless transceiver is internal to the STB and not shown in external view of the STB. The following input and output ports are shown in FIG. 4, HPNA coax IP video In from the residential gateway (RG) 402, HDMI video/audio 440, component video Pb signal output 406, component video Pr signal output 408, component video Y signal output 410, S video signal output 412, optical digital audio signal output 414, composite video signal output 422, composite video signal output 424, left stereo audio analog signal output 426, left stereo audio analog signal output 428, right stereo audio analog signal output 430, right stereo audio analog signal output 432, RF (channel 3 and 4) signal output and 336 USB port.

Turning now to FIG. 5, an illustrative visual presentation of an STB on an STB display is depicted. As shown in FIG. 5, in an illustrative embodiment, the test signal from the STB displays, on a MMP display such as a television screen 508 a graphic representation of the STB front panel 501 and STB back panel 503 with output ports. As shown in FIG. 5, a user can move an RC cursor 502 over each of the displayed graphical representation of the output ports to a selected graphical representation output port 402, at which time the STB display will display an instructional message explaining the use of the selected output port and display graphic representations of appropriate peripherals including but not limited to speakers 505, TVs, lap top computers 507, Digital Video Players, etc. as appropriate to the selected output port) which can be connected to the selected output port and how to connect them. In another illustrative embodiment a sound reproductive device on the STB can audibly announce the instructional message explaining the use of the selected output port and appropriate peripherals which can be connected to the selected output port and how to connect them.

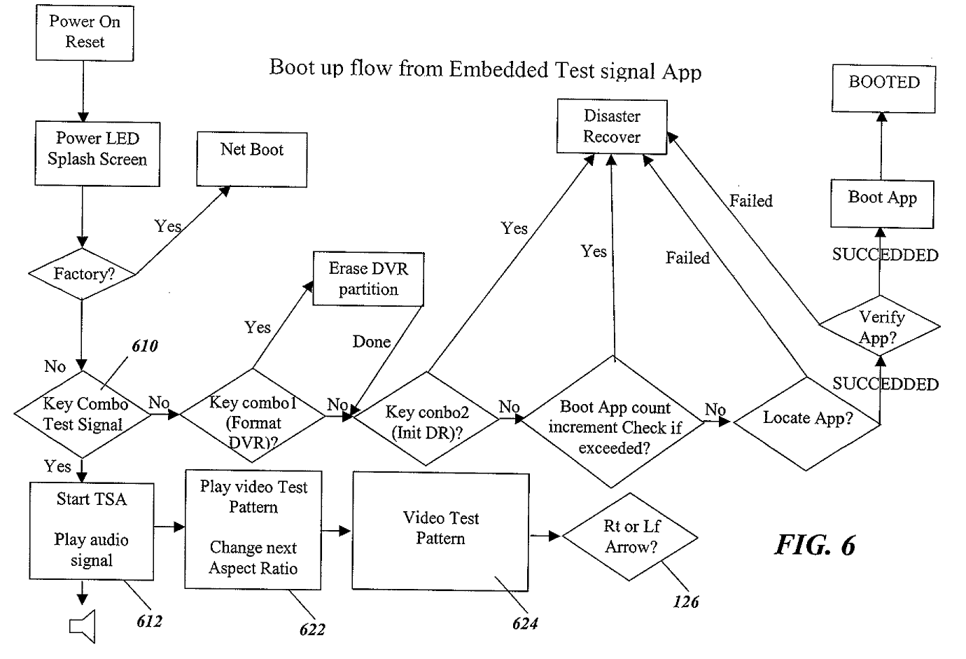

Turning now to FIG. 6, in a particular embodiment, the STB further responds by sending a video output signal on all video display output ports (also referred to herein as interfaces) with a default aspect ration of 4×3 for display on an STB display peripheral such as a television. The output ratio can be changed by pressing either the right or left arrow to display a higher or lower resolution setting as well as displaying a corresponding test pattern for the higher or lower resolution. Three resolution test patterns (480i, 1080i and 720p) are output for display sequentially on all video output ports or interfaces, which allows an end user at the STB to connect peripherals to any and all outputs to confirm that connectivity is established and working between the STB and the peripherals. As shown in FIG. 6, at decision point 610 an illustrative embodiment determines is an initiation key combination has been entered to the STB. If yes, an illustrative embodiment proceeds to block 612 and starts the test signal method described herein by sending an audio signal to all audio output ports on the STB and at block 622 sends a video test pattern 624 to all video output ports on the STB for display on the peripheral display devices. An illustrative embodiment checks 626 to see if the right or left front panel arrows are entered by a user and changes the video test pattern resolution and or aspect ratio according upon entry of the left or right arrow. The video test pattern is also useful in enabling a user to adjust color on their display peripheral device. The audio test pattern is introduced into the STB audio processing circuitry at the same point as an audio signal is introduced to the STB audio processing circuitry when received from the IPTV system and thus may indicate problems in the internal STB audio processing circuitry during the test.

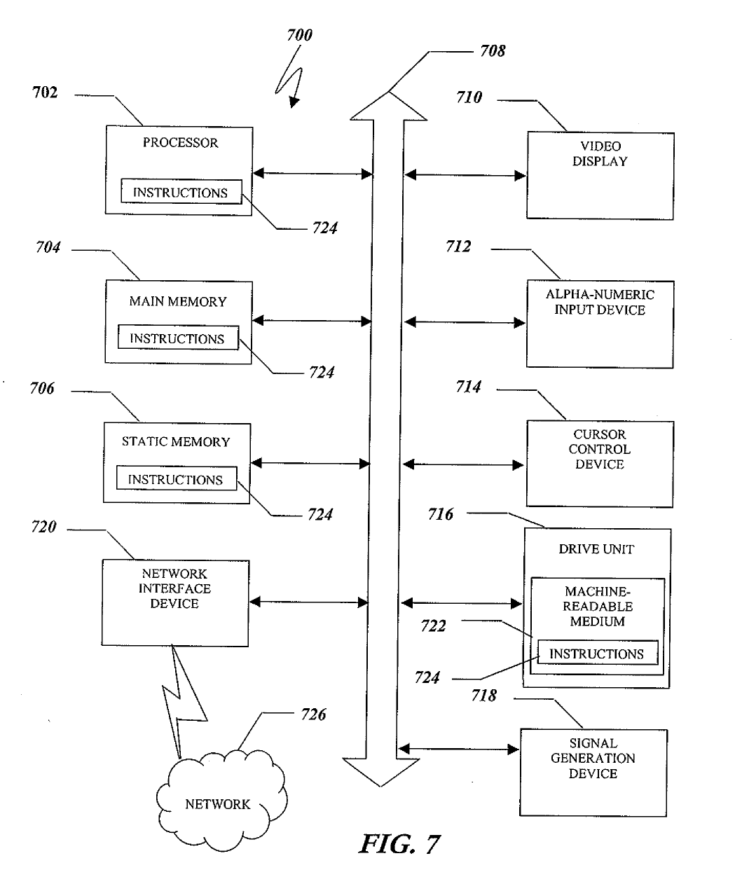

Turning now to FIG. 7, FIG. 7 is a diagrammatic representation of a machine in the form of a computer system 700 within which a set of instructions, when executed, may cause the machine, also referred to as a computer, to perform any one or more of the methodologies discussed herein. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. The machine may comprise a server computer, a client user computer, a personal computer (PC), a tablet PC, a set-top box (STB), a Personal Digital Assistant (PDA), a cellular telephone, a mobile device, a palmtop computer, a laptop computer, a desktop computer, a personal digital assistant, a communications device, a wireless telephone, a land-line telephone, a control system, a camera, a scanner, a facsimile machine, a printer, a pager, a personal trusted device, a web appliance, a network router, switch or bridge, or any machine capable of executing a set of instructions (sequential or otherwise) that specify actions to be taken by that machine. It will be understood that a device of the illustrative includes broadly any electronic device that provides voice, video or data communication. Further, while a single machine is illustrated, the terms “machine” and “computer” shall also be taken to include any collection of machines that individually or jointly execute a set (or multiple sets) of instructions to perform any one or more of the methodologies discussed herein.

The computer system 700 may include a processor 702 (e.g., a central processing unit (CPU), a graphics processing unit (GPU), or both), a main memory 704 and a static memory 706, which communicate with each other via a bus 708. The computer system 700 may further include a video display unit 710 (e.g., liquid crystals display (LCD), a flat panel, a solid state display, or a cathode ray tube (CRT)). The computer system 700 may include an input device 712 (e.g., a keyboard), a cursor control device 714 (e.g., a mouse), a disk drive unit 716, a signal generation device 718 (e.g., a speaker or remote control) and a network interface device 720.

The disk drive unit 716 may include a computer-readable and machine-readable medium 722 on which is stored one or more sets of instructions (e.g., software 724) embodying any one or more of the methodologies or functions described herein, including those methods illustrated in herein above. The instructions 724 may also reside, completely or at least partially, within the main memory 704, the static memory 706, and/or within the processor 702 during execution thereof by the computer system 700. The main memory 704 and the processor 702 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the illustrative embodiment, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The illustrative embodiment contemplates a computer-readable and machine-readable medium containing instructions 724, or that which receives and executes instructions 724 from a propagated signal so that a device connected to a network environment 726 can send or receive voice, video or data, and to communicate over the network 726 using the instructions 724. The instructions 724 may further be transmitted or received over a network 726 via the network interface device 720.

While the machine-readable medium 722 is shown in an example embodiment to be a single medium, the terms “machine-readable medium” and “computer-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the illustrative embodiment. The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and/or a digital file attachment to e-mail or other self-contained information archive or set of archives is considered a distribution medium equivalent to a tangible storage medium. Accordingly, the illustrative embodiment is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the illustrative embodiment is not limited to such standards and protocols. Each of the standards for Internet and other packet switched network transmission (e.g., TCP/IP, UDP/IP, HTML, and HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “illustrative embodiment” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

Although the illustrative embodiment has been described with reference to several illustrative embodiments, it is understood that the words that have been used are words of description and illustration, rather than words of limitation. Changes may be made within the purview of the appended claims, as presently stated and as amended, without departing from the scope and spirit of the illustrative embodiment in its aspects. Although the illustrative embodiment has been described with reference to particular means, materials and embodiments, the invention is not intended to be limited to the particulars disclosed; rather, the invention extends to all functionally equivalent structures, methods, and uses such as are within the scope of the appended claims.

In accordance with various embodiments of the present illustrative embodiment, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

1. A computer readable medium containing computer program instructions that when executed by a computer concurrently send a plurality of test signals from a multimedia processor, the computer program instructions comprising instructions to accept a test initiation signal at the multimedia processor; and instructions to concurrently send at least one of a plurality of test signals from each one of a plurality of output ports on the multimedia processor.

2. The medium of claim 1, the computer program instructions further comprising instructions to present on the multimedia processor, a working indication, perceptible on the multimedia processor that all multimedia processor output ports are operational.

3. The medium of claim 1, wherein at least one of the plurality of test signals further comprise a visual presentation of the multimedia processor output ports for presentation on a multimedia processor display.

4. The medium of claim 3, the computer program instructions further comprising instructions to accept selection input data indicating one of the multimedia processor output ports, the computer program further comprising instructions to present an instructional message explaining operation of the multimedia processor output port.

5. The medium of claim 4, wherein the instructional message further comprises data selected from the group consisting of graphical, video and audio data.

6. The medium of claim 4, the computer program instructions further comprising instructions to present a representation of a peripheral device from the output port.

7. The medium of claim 1, wherein the test signals are data selected from a group consisting of video, audio, communication and optical data.

8. The medium of claim 2, wherein the working indication consists of data selected from the set consisting of audible and visible data.

9. A system for providing a plurality embedded test signals from a multimedia processor, the system comprising:
a multimedia processor;
a processor in the multimedia processor, wherein the processor is in data communication with a computer readable medium on the multimedia processor;
a first interface to accept a test initiation signal at the multimedia processor;
a second interface to send a first test signal from the multimedia processor; and
a third interface to send a second test signal concurrently with the first test signal from the multimedia processor, wherein at least one of the first and second test signals further comprise a visual presentation of the multimedia processor output ports for presentation on a multimedia processor display.

10. The system of claim 9, the system further comprising:
a working indication device, configured to present working indication data perceptible on the multimedia processor operable to indicate that all multimedia processor output ports are operational.

11. The system of claim 9, wherein at least one of the first and second test signals further comprises a presentation of an instructional message explaining operation of the multimedia processor output port.

12. The system of claim 11, wherein the instructional message further comprises data selected from the group consisting of graphical, video and audio data.

13. The system of claim 9, the system further comprising a display device configured to display data from the output port indicating a graphical representation of a peripheral device.

14. The system of claim 9, wherein the first and second test signals data are selected from a group consisting of video, audio, communication and optical data.

15. The system of claim 10, wherein the working indication consists of data selected from the set consisting of audible and visible data.

16. A method for sending a plurality of test signals from a multimedia processor, the method comprising:
accepting a test initiation signal at the multimedia processor;
sending concurrently the plurality of test signals from a plurality of output ports on the multimedia processor for testing operation of the multimedia processor and peripherals receiving the test signals from the multimedia processor;
accepting a selection input from a user at the multimedia processor, indicating one of the plurality of multimedia processor output ports; and
presenting an instructional message explaining operation of the multimedia processor output port.

17. The method of claim 16, further comprising:
presenting on the multimedia processor, a working indication, perceptible on the multimedia processor that all multimedia processor output ports are operational.

18. The method of claim 16, wherein at least one of the plurality of test signals further comprise a visual presentation of the multimedia processor out put ports for presentation on a multimedia processor display.

19. The method of claim 17, wherein the working indication consists of data selected from the set consisting of audible and visible data.

20. The method of claim 16, wherein the first test signal further comprises graphical data for displaying a graphical display of the output ports and the second test signal further comprises audio data explaining the operation of a selected output port displayed on the graphical display selected by an end user using a remote control.
